(19) United States
(12) Patent Application Publication
(10) Pub. No.: US 2024/0174534 A1
(43) Pub. Date: May 30, 2024

(54) RESPONSIVE PRODUCTION AND DELIVERY OF VARIABLE COMPOSITION AQUEOUS HALOGENS IN WATER TREATMENT APPLICATIONS

(71) Applicant: DE NORA HOLDINGS US, INC., Concord, OH (US)

(72) Inventor: Andrew K. Boal, Concord, OH (US)

(21) Appl. No.: 18/551,921

(22) PCT Filed: Apr. 13, 2022
(86) PCT No.: PCT/US22/24613

§ 371 Date: Sep. 22, 2023

Related U.S. Application Data
(60) Provisional application No. 63/174,919, filed on Apr. 14, 2021.

(51) Int. Cl. C02F 1/467; C02F 1/00; C02F 1/68; C02F 1/76; C02F 103/02; C02F 103/42

(52) U.S. Cl. CPC C02F 1/4674; C02F 1/008; C02F 1/686; C02F 1/76; C02F 2103/023; C02F 2103/42; C02F 2209/008; C02F 2209/02; C02F 2209/04; C02F 2209/06; C02F 2209/29

(57) ABSTRACT

Systems and methods that enable the responsive treatment of a body of water with an aqueous halogen solution whose composition can be varied as a result of input from sensors monitoring the water being treated. Various sensors are immersed in the water so that the physical, chemical, and microbiological properties of a body of water being treated can be measured. Information from these sensors is used to produce aqueous halogen solutions of varying composition which are then injected into the body of water being monitored for the purposes of ensuring the body of water being treated is being effectively disinfected.

### TECHNICAL FIELD

The present invention is generally related to the production of aqueous halogen solutions. In particular, the present invention is directed to automatically varying the composition of an aqueous halogen solution used in a water treatment process using telemetry from remote sensors.

### BACKGROUND OF THE INVENTION

Aqueous halogens are commonly used to control bacteria populations in water. In some water treatment scenarios, where the water being treated is recycled multiple times or indefinitely through a process, for example a cooling tower, swimming pool, or a decorative water feature such as a fountain, it is known that treatment of the water with stabilized aqueous halogens can result in a situation where there is a large excess of the halogen stabilizing compound relative to the aqueous halogen in the water being treated. When this occurs, the aqueous halogen becomes over stabilized and, as a result, the disinfection efficacy of the treatment can be diminished. Additionally, bacteria in water being treated can, in some cases, become resistant to treatment with stabilized aqueous halogens through the formation of biofilms.

In these scenarios, it is recognized by those skilled in the art that either varying the nature of the biocide applied to the water or altering the dose of the biocide can resolve the issues and improve the disinfection process. This may involve increasing the applied dose of biocide, also known as shock dosing or slug dosing, or, in the case of halogen over stabilization, replacing the stabilized halogen with an unstabilized halogen. Traditionally, this process is undertaken by personnel monitoring water quality and manually making changes in the biocides added to the water manually. There is, therefore, a need to automate this process so that a desired aqueous halogen solution composition can be provided in situ to optimally disinfect the water to be treated.

### SUMMARY

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

Embodiments of the present invention involve automatically varying the composition of an aqueous halogen solution used in a water treatment program using telemetry data from sensors placed in the body of water being treated. The telemetry data can be used to provide feedback to a control system to vary the composition of the aqueous halogen solution.

Systems and methods of automating this process through the use of water quality sensors coupled to devices capable of producing oxidizer solutions of varying compositions are taught in this present invention and will be understood by those skilled in the art to be an improvement over the existing art.

According to an embodiment, a system for producing a mixed aqueous halogen solution for treating water includes a sensor package having one or more sensors for detecting a characteristic of the water; and an electrochlorination apparatus configured to receive the detected data and, in dependence thereof, produce an oxidizing solution having at least two stabilized halogen species.

The water to be treated can be contained within a reservoir. The sensor package is at least partially immersed in the water contained in the reservoir. The one or more sensors can be selected from the group consisting of: pH sensors, oxidation/reduction potential sensors, temperature sensors, biofilm sensors and combinations thereof. The sensors measure predetermined physical, chemical, and microbiological properties of the water being treated.

The system further comprises a first piping. The first piping is configured to deliver fresh water to the electrochlorination apparatus. The first piping is further configured to route a mixture of a first aqueous solution having a first halogen specie and a second aqueous solution having a second halogen specie to the electrochlorination apparatus.

The first piping is in fluidic communication with a first tank. The first aqueous solution is contained in the first tank. A first pump is coupled to the first tank. The first pump is configured to receive a signal from the electrochlorination apparatus and, in dependence thereof, pump or inject a predetermined amount of the first aqueous solution into the first piping. The first piping is also in fluidic communication with a second tank. The second aqueous solution is contained in the second tank. A second pump is coupled to the second tank. The second pump is configured to receive a signal from the electrochlorination apparatus and, in dependence thereof, pump or inject a predetermined amount of the second aqueous solution into the first piping.

In one embodiment, the first aqueous solution is sodium chloride, and the second aqueous solution is either sodium bromide or sodium iodide. The first and/or the second aqueous solution further includes a halogen stabilizing agent.

The system further includes a third tank, wherein the third tank is configured for storing the oxidizing solution generated by the electrochlorination apparatus. A second piping is used to route the oxidizing solution from the electrochlorination apparatus to the third tank. The oxidizing solution is stored in the third tank until it is needed to be routed to via a third piping to the water to be treated. Accordingly, using information from these sensors, aqueous halogen solutions of varying composition can be then injected into the water to ensure that it is effectively disinfected.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1. is a schematic drawing of an embodiment of the present invention.

FIG. 2. is a schematic drawing of an embodiment of the present invention having an electrolysis system for generating a multicomponent oxidizing solution from precursor chemicals.

FIG. 3. is a schematic drawing of an embodiment of the present invention showing the production of multicomponent oxidizing solutions through the mixing of individual oxidizing chemicals and oxidant stabilizing chemicals.

FIG. 4 is a schematic drawing of yet another embodiment of the present invention.

### DETAILED DESCRIPTION

Embodiments of the present invention, as well as the practice of the present invention, are intended to produce an aqueous solution comprised of two or more different aqueous oxidizing species in any desired ratio between the two or more aqueous oxidizing species where the composition of the individual oxidizing species is varied as a result of sensor input from the water being treated by the aqueous solution. Advantages of the practice of the present invention as taught by this disclosure will be understood by those skilled in the art to be an improvement over the prior art where these steps were undertaken on a manual basis.

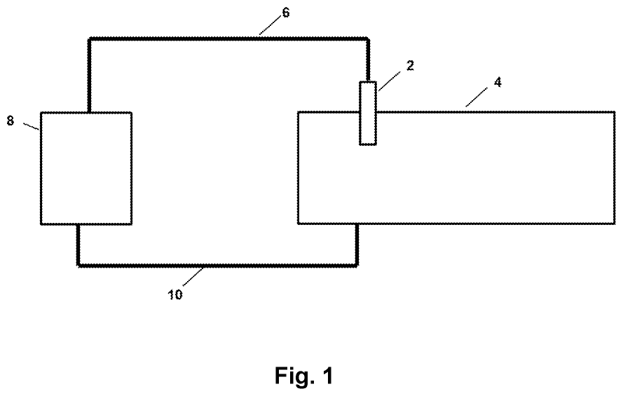

In an embodiment of the present invention, as shown in FIG. 1, a sensor package 2 is placed so that one or more sensors in the package are immersed in the water contained in reservoir 4. Sensor packages are known in the art. A sensor package can usually include a carrier, a sensor and a housing. Sensors incorporated into sensor package 2 can include, but are not limited to, pH sensors, oxidation/reduction potential (ORP) sensors, temperature sensors, biofilm sensors, or combinations thereof. Reservoir 4 can be any contained body of water being treated such as, but not limited to, a cooling tower, swimming pool, water tank, or a decorative water feature such as a fountain.

Data detected/collected by sensor package 2 is transmitted along conduit 6 to an apparatus 8. Here, conduit 6 is preferably a wired connection to apparatus 8, but, optionally, data detected/collected from sensor package 2 can be transmitted to apparatus 8 through wireless means as well. The apparatus 8 is configured to produce oxidizing solutions (as described later herein). The terms “oxidizing solution” and “oxidizing biocide” are used interchangeably in this application. The oxidizing solution can include a variety of stabilized and unstabilized halogen species including, without limitation, dissolved molecular chlorine, dissolved molecular bromine, dissolved molecular iodine, hypochlorous acid, hypobromous acid, hypoiodous acid, hypochlorite ions, hypobormite ions, hypoiodite ions, N-chlorosulfamate ions, N-bromosulfamate ions, N-iodosulfamate ions, N,N-dichlorosulfamate ions, N,N-dibromosulfamate ions, N,N-diiodosulfamate ions, N-chloro-N-bromosulfamate ions, N-chloro-N-iodosulfamate ions, N-bromo-N-iodosulfamate ions, N-chlorosulfamic acid, N-bromosulfamic acid, N-iodosulfamic acid, N,N-dichlorosulfamic acid, N,N-dibromosulfamic acid, N,N-diiodosulfamic acid, N-chloro-N-bromosulfamic acid, N-chloro-N-iodosulfamic acid, N-brom-N-iodoosulfamic acid, N-chlorotaurine, N-bromotaurine, N-iodotaurine, N,N-dichlorotaurine, N,N-dibromotaurine, N,N-diiodotaurine, N-bromo-N-chlorotaurine, N-bromo-N-iodotaurine, N-chloro-N-iodotaurine, 1-chloro-5,5-dimethylhydantoin, 1-bromo-5,5-dimethylhydantoin, 1-iodo-5,5-dimethylhydantoin, 1,3-dichloro-5,5-dimethylhydantoin, 1,3-dibromo-5,5-dimethylhydantoin, 1,3-diiodo-5,5-dimethylhydantoin, 1-chloro-3-bromo-5,5-dimethylhydantoin, 1-chloro-3-iodo-5,5-dimethylhydantoin, 1-bromo-3-chloro-5,5-dimethylhydantoin, 1-bromo-3-iodo-5,5-dimethylhydantoin, 1-iodo-3-chloro-5,5-dimethylhydantoin, 1-iodo-3-bromo-5,5-dimethylhydantoin, and combinations thereof. Once the oxidizing solution has been produced by the apparatus 8, the solution is then transferred or routed to the water in reservoir 4 along piping/pipeline/line 10. In one or more embodiment, apparatus 8 can use the data provided by sensor package 2 to change the composition of the oxidant solution produced by apparatus 8 to optimize the composition of the oxidant solution and thereby improve the overall water treatment process.

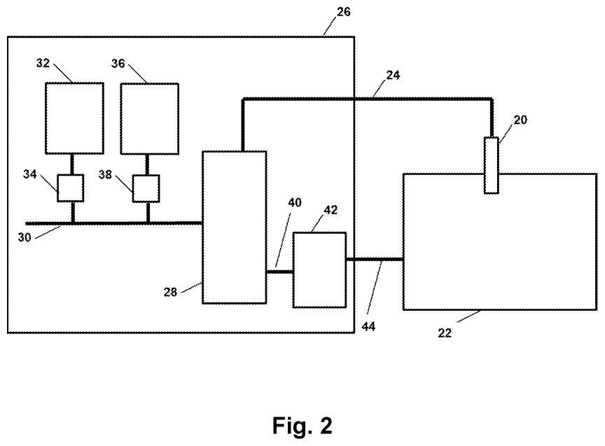

In a preferred embodiment of the present invention, as shown in FIG. 2, sensor package 20 is placed so that the sensors in the package are immersed in the body of water contained in reservoir 22. Sensors that can be incorporated into sensor package 20 can include, but are not limited to, pH sensors, oxidation/reduction potential sensors, temperature sensors, biofilm sensors, or combinations thereof. Reservoir 22 can be any contained body of water being treated such as, but not limited to, a cooling tower, swimming pool, water tank, or a decorative water feature such as a fountain. Data collected by sensor package 20 is transmitted along conduit 24 to a system 26. Here, conduit 24 is preferably a wired connection to system 26, but, optionally, data collected from sensor package 20 can be transmitted to system 26 through wireless means as well.

System 26 contains an electrochlorination device 28 that is fed fresh water from line 30. In the practice of the present invention, the electrochlorination device 28 is accomplished using an electrolytic cell comprising at least one cathode and at least one anode, although some embodiments of the present invention will also include several intermediate electrode plates to form a bipolar cell. Electrodes can be of any suitable material, but preferably Dimensionally Stable Anodes (which can be used as both the anode and cathode) are used in the present invention. Voltage applied to the electrolytic cell is preferably approximately 6V. However, it is understood that any suitable electrolytic cell can be used in the practice of the invention. Additionally, a first aqueous solution from a first tank 32 is injected into line 30 through the action of a first pump 34. A second aqueous solution from a second tank 36 is injected into line 30 through the action of a second pump 38. The combination of the first and second aqueous fluids then enters electrochlorination device 28. Electrochlorination device 28 comprises an electrochemical cell. A current is applied to the combined aqueous fluid to produce an oxidizing solution. The oxidizing solution is then transferred along line 40 to a third tank 42, where the oxidizing solution is stored. When needed, the oxidizing solution is transferred along line 44 to the water contained in reservoir 22. In one or more embodiments, the transfer of oxidizing solution can be controlled by an end user—either manually by sending a signal to turn on the injection pump or through an automated process that, for example, measures the halogen residual level in the water being treated.

In this embodiment of the present invention, at least one of the aqueous solutions contained in tanks 32 and 36 includes at least one halide containing salt. Preferably, this solution includes an aqueous sodium chloride preferably at saturation, although a variety of other halide containing salt solutions can also be used. The aqueous solution in the second tank can preferably include a second halide containing salt wherein the second halide component is different than the halide component in the first tank. As an example, if the aqueous solution in tank 32 is sodium chloride, the aqueous solution contained in the second tank is a bromide or iodide containing salt.

Additionally, the solutions contained within tanks 32 and 36 can also include a halogen stabilizing agent or compound that can be present in either or both tanks. As used herein, the term “halogen stabilizing agent” includes organic or inorganic amine compounds containing at least one nitrogen atom and that include at least one nitrogen to hydrogen bond. When aqueous halogens and halogen stabilizing compounds are combined, the aqueous halogen reacts with the halogen stabilizing compound to convert the nitrogen to hydrogen bond into a nitrogen to halogen bond, effectively producing N-haloamine compounds. Halogen stabilizing compounds can include, without limitation, sulfamic acid, sulfamate salts, hydantoin, 5,5-dimethylhydantoin, taurine, and cyanuric acid. Preferably, this halogen stabilizing compound is sulfamic acid or sulfamate salts, but in practice, any suitable halogen stabilizing compound can be used in the practice of this invention.

When the halide containing solutions pass through the electrochemical cell and a current is applied to the cell, the halide ions will be electrochemically oxidized to produce aqueous halogen species which can then react with each other, for example the oxidation of bromide ions by aqueous chlorine species, or with halogen stabilizing compounds to produce the desired oxidant solution that is comprised of multiple oxidizing species. As an example, if tank 32 contains an aqueous solution having sodium chloride and water, and tank 36 contains an aqueous solution having sodium bromide, sulfamic acid and water, the product solution can include a combination of dissolved molecular chlorine, dissolved molecular bromine, hypochlorous acid, hypobromous acid, hypochlorite ions, hypobormite ions, N-chlorosulfamate ions, N-bromosulfamate ions, N,N-dichlorosulfamate ions, N,N-dibromosulfamate ions, N-chloro-N-bromosulfamate ions, N-chlorosulfamic acid, N-bromosulfamic acid, N,N-dichlorosulfamic acid, N,N-dibromosulfamic acid, N-chloro-N-bromosulfamic acid, and any combination thereof.

In the practice of the present invention, data acquired by sensor package 20 will be used by the electrochlorination device 28 to vary the amount of aqueous solutions transferred from tanks 32 and 36, which will impact the composition of the oxidant solution. For instance, the electrochlorination device is configured to communicate with first pump 34 to pump/inject a predetermined amount of the first aqueous solution into the first piping. Similarly, the electrochlorination device is configured to communicate with second pump 38 to pump/inject a predetermined amount of the second aqueous solution into the first piping 30.

In the one or more embodiments of the present invention, the one or more sensors in the sensor package can be configured to determine when halogen overstabilization occurs and then alter the composition of the halogen solution being used to treat the water. This is accomplished by decreasing the relative amount of stabilizing chemical in the formulation of the oxidizer solution, thereby ensuring that the intended anti-microbial efficacy of the oxidizing biocide is not limited or restricted. This goal can be accomplished by monitoring one or more parameters of the water being treated such as the ORP, pH, or halogen content.

Similarly, microbiological properties of the water, including both the populations of microorganisms as well as the presence of biofilms, can be measured to directly monitor the efficacy of the applied aqueous halogen solutions to ensure proper microbial population control is being achieved. The input from the sensors can be used to determine when the applied dosage of the aqueous halogen should be increased to ensure proper levels of disinfection are achieved or decreased to ensure that excess aqueous halogen is not added to the water that could potentially damage equipment through expedited corrosion rates.

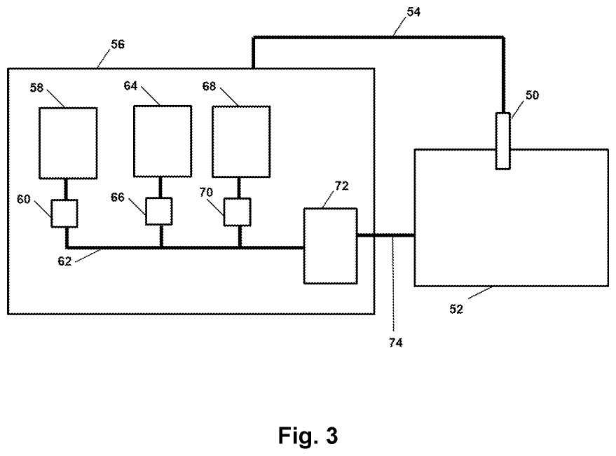

In another embodiment of the present invention, as shown in FIG. 3, a sensor package 50 is placed so that the sensors in the package are immersed in the body of water contained in reservoir 52. Sensors that can be incorporated into sensor package 50 can include, but are not limited to, pH sensors, oxidation/reduction potential sensors, temperature sensors, biofilm sensors, or combinations thereof. Reservoir 52 can be any contained body of water being treated such as, but not limited to, a cooling tower, swimming pool, water tank, or a decorative water feature such as a fountain. Telemetry data collected by sensor package 50 is transmitted along conduit 54 to a system 56 for producing aqueous solutions of oxidizing chemicals and/or oxidant stabilizing chemicals. Here, conduit 54 is preferably a wired connection to system 56, but, optionally, data collected from sensor package 50 can be transmitted to system 56 through wireless means as well.

System 56 contains a plurality of tanks which are each configured to hold individual aqueous solutions of oxidizing chemicals and/or oxidant stabilizing chemicals. In one example of this embodiment, as shown in FIG. 3, these are tanks 58, 64, and 68, which have associated pumps 60, 66, and 70. Aqueous solutions from tanks 58, 64, and 68 are transferred to pipe 62 through the action of pumps 60, 66, and 70 to holding tank 72. When needed, the solution contained in holding tank 72 is then transferred to the water contained within reservoir 52 using line 74.

In the practice of this embodiment of the present invention, data from sensor package 50 is used by a control unit (not shown) and contained within system 56 to vary the relative amounts of aqueous solutions contained in tanks 58, 64, and 68 used to make the product oxidant solution by varying the injection rates of pumps 60, 66, and 70. Here, the control unit within system 56 will utilize data from sensor package 50 to determine when changes in the oxidant composition need to be made and as well as what changes should be made to the composition of the product oxidant solution. In one or more embodiments, the control unit can be configured to take input from the sensors and then use that input to change the injection rates of the pumps from each tank. Advantageously, this results in changing the composition of the oxidizing biocide solution. As an example, if tank 58 contains an aqueous solution comprised of sodium hypochlorite and water, tank 64 contains an aqueous solution comprised of sodium hypobromite and water, and tank 68 contains an aqueous solution comprised of sodium sulfamate and water, the product solution can be comprised of a combination of hypochlorite ions, hypobromite ions, N-chlorosulfamate ions, N-bromosulfamate ions, N,N-dichlorosulfamate ions, N,N-dibromosulfamate ions, N-chloro-N-bromosulfamate ions, and any combination thereof.

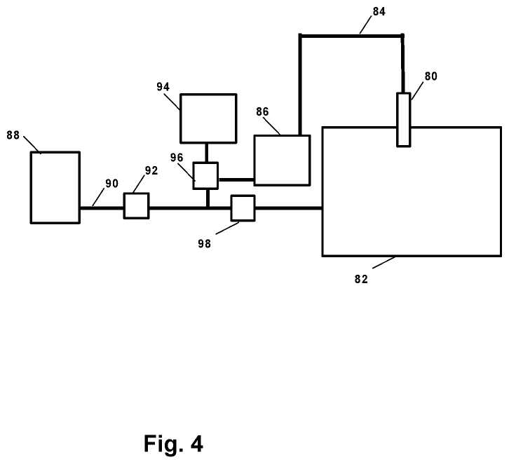

An alternative embodiment of the present invention is shown in FIG. 4. Here, sensor package 80 is immersed in the water being treated contained in reservoir 82. Telemetry is sent along line 84 to control system 86. Tank 88 contains a first component of a mixed halogen solution which can be transferred along pipe 90 through the action of pump 92. A second component of the mixed halogen solution is contained in tank 94 and is transferred into line 90 through the action of pump 96. The mixed halogen solution then passes by inline mixer 98 and is ultimately injected in the water contained within reservoir 82. Tank 88 and/or tank 94 can further include a halogen stabilizing agent. As an example of the practice of this embodiment of the present invention, tank 88 could contain a sodium hypochlorite solution, preferably produced through the use of a brine electrochlorination process, while tank 94 could contain sodium bromide. Action of pump 96 would be used to generate the desired mixed halogen solution comprised of both aqueous chlorine and aqueous bromine. Alternately, tank 94 could contain a mixture of both sodium bromide and sulfamic acid which, when mixed with the sodium hypochlorite from tank 88, would result in the desired mixed halogen solution comprised of both stabilized and unstabilized aqueous chlorine and aqueous bromine. Additional alternative embodiments of this embodiment can include the use of a plurality of pumps connected to control system 86 and sensor package 80 which can inject a plurality of chemicals into an initial chemical to produce a desired multiple component solution.

Practitioners skilled in the art will recognize the benefits of the present invention over traditional water treatment methods which use the intervention of water treatment personnel to both monitor the quality of the water being treated as well as any changes in the aqueous halogen solution being used to treat the water. In the case of the present invention, which uses data acquired from sensors to both monitor water quality and automatically adjust the composition of the aqueous halogen solution as a result of sensor data, less reliance on personnel is required to do these tasks through an automation process. Practitioners skilled in the art will further understand that there are many other potential embodiments of the present invention that could be used to achieve the same goals as the embodiments described in FIGS. 1, 2, 3, and 4. Other aqueous halogen chemistries beyond the ones specifically described can be used in the practice of the present invention so long as the individual chemistries are compatible when mixed or produced on location.

Practice of the present invention is optimized when preferred blends of mixed halogen solutions are utilized in the water treatment process. For example, in the case of mixtures of bromine and chlorine, it is preferable to have bromine to chlorine molar ratio of between 50:1 and 1:50 with higher excess bromine blends being preferable when treating higher pH waters. In the practice of the present invention, when telemetry from sensor packages 20, 50, or 80 determines that the pH of the water being treated is increasing, the present invention can alter the composition of the mixed halogen solution to increase the relative amount of bromine in the mixed halogen solution. For example, in the embodiment described in FIG. 2, tank 32 can contains sodium chloride while tank 36 contains sodium bromide. The control system can change the injection rates of those two chemicals to modify the chlorine/bromine ratio in the product solution. An example of this responsiveness is given in Table 1, although those skilled in the art will recognize that additional operational factors, such as water temperature or the number of times the water is reused, can impact the which molar ratio is preferable at which pH value.

TABLE 1
Example of preferable mixed halogen solution composition
as a function of treatment water pH

| | Preferred bromine:chlorine molar |
|---|---|
| Treatment water pH | ratio for the mixed halogen solution |
| <7.2 | 1:50 |
| 7.2-7.4 | 1:45 |
| 7.6-7.8 | 1:40 |
| 7.8-8.0 | 1:30 |
| 8.0-8.2 | 1:25 |
| 8.2-8.4 | 1:20 |
| 8.4-8.6 | 1:15 |
| 8.8-9.0 | 1:10 |
| 9.0-9.2 | 1:5 |
| 9.2-9.4 | 1:1 |
| >9.4 | 5:1 |

Similarly, in the practice of the present invention, the measured ORP value of the water being treated can be used to gauge whether or not the mixed halogen solution has become overly stabilized when using stabilized halogens is desirable. For example, if the ORP value of the water being treated drops too low, it would be preferable to treat the water with a less stabilized mixed halogen solution to ensure that the mixed halogen solution is able to effectively result in disinfection. Conversely, if the ORP value of the water being treated rises too high, it would be preferable to treat the water with a more stabilized halogen solution to ensure that the treated water does not become overly corrosive. In the practice of the present invention, the preferable molar ratio between the halogen and a stabilizing agent is 1000:1 to 1:1. In the practice of the present invention, when telemetry from sensor packages 20, 50, or 80 determines that the ORP of the water being treated is decreasing, the present invention can alter the composition of the mixed halogen solution to decrease the relative amount of halogen stabilization. For instance, in the embodiment described in FIG. 2, if tank 32 contains sodium chloride and sodium bromide while tank 36 contains sulfamic acid, the control system can change the injection rates of those two chemicals to modify the amount of stabilization agent that will be in the product solution. An example of this responsiveness is given in Table 2, although those skilled in the art will recognize that additional operational factors, such as water temperature or number of times the water is reused, can impact the which molar ratio is preferable at which ORP value.

TABLE 2
Example of preferable mixed halogen solution composition
as a function of treatment water ORP.

| ORP of Water Being | Preferred halogen:stabilizer molar |
|---|---|
| Treated (mV) | ratio for the mixed halogen solution |
| <100 | 1000:1 |
| 100-200 | 100:1 |
| 200-300 | 50:1 |
| 300-400 | 40:1 |
| 400-500 | 30:1 |
| 500-600 | 20:1 |
| 600-700 | 10:1 |
| 700-800 | 5:1 |
| >800 | 1:1 |

Similarly, feedback from sensors such as 20, 50, or 80, which are capable of sensing biological data such as bacteria populations or growth of biofilm, can be used to vary the composition of the mixed halogen solutions. As above, the preferable bromine to chlorine molar ratio of between 50:1 and 1:50 and the preferable molar ratio between the halogen and a stabilizing agent of 1000:1 to 1:1 changes in response to the increased presence of either planktonic or sessile bacteria in the water being treated. In some cases, it is also preferable to vary between the use of a halogen solution that is stabilized with a halogen solution that is not stabilized.

The one or more embodiments of the present invention can be advantageously applied to a cooling tower water treatment program, although the present invention could also be practiced in a variety of other water treatment scenarios. In the case of cooling towers, it is known to those familiar with the art that overstabilization of halogens can occur when halogen stabilizing compounds are built up in the cooling water as a result of cycles of concentration and that this buildup of over stabilized halogens can decrease the anti-microbial efficacy of the aqueous halogen.

Those skilled in the art will recognize that the present invention can be practiced in other, similar environments such as, but not limited to, swimming pools, other recreational aquatic environments such as water parks, or decorative water features such as fountains, where halogen overstabilization can occur.

Therefore, the present invention is well adapted to attain the ends and advantages mentioned as well as those that are inherent therein. The previous description is not intended to limit the invention, which may be used according to different aspects or embodiments without departing from the scope thereof. The discussion of acts, steps, chemicals, apparatus, components, elements and the like are included in this specification solely for the purpose of providing a context for the present invention. It is not suggested or represented that any or all of these matters formed part of the prior art base or were common general knowledge in the field relevant to the present invention.

Furthermore, the particular illustrative embodiments disclosed above may be altered or modified and all such variations are considered within the scope and spirit of the present invention. While systems and methods are described in terms of “comprising,” “containing,” or “including” various devices/components or steps, it is understood that the systems and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. If there is any conflict in the usages of a word or term in this specification, claims and one or more patent(s) or other documents that may be incorporated herein by reference, the definitions that are consistent with this specification should be adopted.

1. A system for producing a mixed aqueous halogen solution for treating water, comprising:
a sensor package, wherein the sensor package is immersed in the water being treated, the sensor package comprising one or more sensors for detecting a characteristic of the water, wherein at least one or more sensors are configured to determine halogen overstabilization; and
an electrochlorination apparatus configured to receive the detected data and, in dependence thereof, produce an oxidizing solution having at least two stabilized halogen species.

2. The system according to claim 1, wherein the water is contained in a reservoir.

3. (canceled)

4. The system according to claim 1, wherein the one or more sensors are selected from the group consisting of: pH sensors, oxidation/reduction potential sensors, temperature sensors, biofilm sensors and combinations thereof.

5. The system according to claim 1, further comprising a first piping, wherein the first piping is configured to deliver fresh water to the electrochlorination apparatus.

6. The system according to claim 5, wherein the first piping is further configured to route a mixture of a first aqueous solution having a first halogen specie and a second aqueous solution having a second halogen specie to the electrochlorination apparatus.

7. The system according to claim 6, further comprising:
a first tank, wherein the first aqueous solution is contained in the first tank; and
a first pump coupled to the first tank.

8. The system according to claim 7, wherein the first pump is configured to receive a signal from the electrochlorination apparatus and, in dependence thereof, pump a predetermined amount of the first aqueous solution into the first piping.

9. The system according to claim 6, further comprising:
a second tank, wherein the second aqueous solution is contained in the second tank; and
a second pump coupled to the second tank.

10. The system according to claim 9, wherein the second pump is configured to receive a signal from the electrochlorination apparatus and, in dependence thereof, pump a predetermined amount of the second aqueous solution into the first piping.

11. The system according to claim 6, wherein the first aqueous solution is sodium chloride, and wherein the second aqueous solution is either sodium bromide or sodium iodide.

12. The system according to claim 6, wherein the first and/or the second aqueous solution further includes a halogen stabilizing agent.

13. The system according to claim 1, further comprising a third tank, wherein the third tank is configured for storing the oxidizing solution.

14. The system according to claim 13, further comprising piping means for transferring the oxidizing solution to the water.

15. A system for producing a mixed aqueous halogen solution for treating water contained in a reservoir, comprising:
a sensor package, wherein the sensor package is immersed in the water being treated, the sensor package comprising one or more sensors for detecting a characteristic of the water in the reservoir, and wherein at least one or more sensors are configured to determine halogen overstabilization;
at least two tanks, wherein a first tank is configured to store a first aqueous solution of oxidizing chemicals or oxidant stabilizing chemicals and a second tank is configured to store a second aqueous solution of oxidizing chemicals or oxidant stabilizing chemicals; and
a plurality of injection pumps, wherein at least one pump is in fluid connection with the first tank and at least one pump is in fluid connection with the second tank,
wherein data from the sensor package is configured to vary a relative amount of the aqueous solution pumped from each of the first and second tanks by varying an injection rate of the injection pumps.

16. The system according to claim 15, further comprising an inline mixer, wherein the inline mixer is in fluid connection with the first and second tanks, and wherein a mixture of the first and second aqueous solutions is passed through the inline mixer.

17. The system according to claim 16, wherein the inline mixer is configured to inject a mixed first and second aqueous solution into the reservoir.

18. A system for producing a mixed aqueous halogen solution for treating water contained in a reservoir, comprising:
a sensor package, wherein the sensor package is immersed in the water being treated, the sensor package comprising one or more sensors for detecting a characteristic of the water in the reservoir, and wherein at least one or more sensors are configured to determine halogen overstabilization; and
an apparatus configured to receive the detected data and, in dependence thereof, produce an oxidizing solution having at least two halogen species.

19. (canceled)

20. The system according to claim 18, wherein the one or more sensors are selected from the group consisting of: pH sensors, oxidation/reduction potential sensors, temperature sensors, biofilm sensors and combinations thereof.

21. The system according to claim 18, wherein the data detected by sensor package is transmitted along a conduit to the apparatus.

22. The system according to claim 18, wherein the oxidizing solution is routed to the water in the reservoir.
